(19) United States
(12) Patent Application Publication
(10) Pub. No.: US 2006/0136996 A1
(43) Pub. Date: Jun. 22, 2006

(54) Portable digital data storage device

(75) Inventors: Chih-Ling Wang, Taipei (TW); Yao-Shan Hung, Taipei (TW)

Correspondence Address: MADSON & AUSTIN;GATEWAY TOWER WEST, SUITE 900, 15 WEST SOUTH TEMPLE, SALT LAKE CITY, UT, 84101, US

(73) Assignee: Genesys Logic, Inc.

(21) Appl. No.: 11/266,403

(22) Filed: Nov. 3, 2005

(30) Foreign Application Priority Data
Dec. 16, 2004 (TW) 093139218

(51) Int. Cl. H04L 9/32

(52) U.S. Cl. 726/4

(57) ABSTRACT

In a portable digital data storage device, a connector is attachable to a digital data processor to provide electric connection with the digital data processor. A non-volatile memory module includes a first logic unit for storing data and a second logic unit for storing therein an application program. The application program is automatically executed when the connector is electrically connected to the digital data processor to provide a user's operation interface. A verifying unit executes a verifying procedure for information entered via the user's operation interface. Under the control of a control unit, the digital data processor is disallowed to access to the first logic unit through the connector until the correctness of the information entered via the user's operation interface is verified by the verifying unit.

### FIELD OF THE INVENTION

The present invention relates to a portable digital data storage device, and more particularly to a portable digital data storage device for use with a computer system.

### BACKGROUND OF THE INVENTION

Referring to FIG. 1, the configuration of a conventional computer system is shown. The computer system principally comprises a microprocessor 10, a north bridge chip 11, a south bridge chip 12, a system memory 13 and several storage devices including a hard disc 14, an optical disc drive 15 and a portable digital data storage device such as a USB flash drive 18. The hard disc 14 and the optical disc drive 15 are electrically connected to the south bridge chip 12 via IDE (Integrated Device Electronics) bus 16. In contrast, the USB flash drive 18 is electrically connected to the south bridge chip 12 via a USB bus 17.

For enhancing security, a flash memory 180 of the USB flash drive 18 is usually divided into two memory portions. One is a public memory portion 1801, which is open for being arbitrarily accessed to, and the other is a protective memory portion 1802, which is accessible only when the user passes a verifying procedure. For example, the verifying procedure includes the step of entering a correct password or checking a validate fingerprint.

Generally, an application program need be installed in the computer system for executing the verifying procedure on the computer system. By executing the application program, a user's operation interface is shown for designating memory portions as public or protective ones, setting or amending the information required for access to the protective memory portion, e.g. password or fingerprint, and entering verifying information therevia, and then verifying the entered information. In other words, the application program is essential to perform the verifying procedure of the USB flash drive 18 in order to access the protective memory portion 1802 or modify the data stored therein. For a computer system without installing therein the associated application program, the access to the protective memory portion of the USB flash drive 18 will fail. That is, the application program has to be installed before the data stored in the protective memory portion 1802 of the USB flash drive 18 can be read by the computer system. Therefore, if the USB flash drive 18 is to be used with a foreign computer system, the application program has to be troublesomely installed to that computer system with a setup CD-ROM or downloaded from the Internet. It would also be bothersome for other people.

### SUMMARY OF THE INVENTION

The present invention provides a portable digital data storage device capable of implementing data security while being accessed to without installing any application program into the associated computer system in advance.

In accordance with a first aspect of the present invention, there is provided a portable digital data storage device. The portable digital data storage device comprises a connector, a non-volatile memory module, a verifying unit and a control unit. The connector is attachable to a digital data processor to provide electric connection with the digital data processor. The non-volatile memory module includes a first logic unit for storing data and a second logic unit for storing therein an application program. The application program is automatically executed when the connector is electrically connected to the digital data processor to provide a user's operation interface. The verifying unit is used for executing a verifying procedure for information entered via the user's operation interface. The control unit is electrically connected to the connector, the non-volatile memory module and the verifying unit, and disallowing the digital data processor to access to the first logic unit through the connector until the correctness of the information entered via the user's operation interface is verified by the verifying unit.

In an embodiment, the digital data processor is a computer system and the connector is a bus connector to be plugged into a bus socket of the digital data processor for transmitting data between the non-volatile memory module and the computer system via a bus.

Preferably, the bus is a universal serial bus (USB).

Alternatively, the bus is an IEEE 1394 bus.

Preferably, the non-volatile memory module is a flash memory module.

Alternatively, the non-volatile memory module is a micro drive.

In an embodiment, the second logic unit is a virtual optical disc drive, and the application program is stored in a root directory of the virtual optical disc drive.

In an embodiment, the non-volatile memory module further includes a third logic unit open for being arbitrarily accessed by the digital data processor.

In an embodiment, the first and third logic units are virtual removable disc drives.

In an embodiment, the information to be verified is a password, and the control unit allows the digital data processor to access to the first logic unit when the password complies with a preset pattern.

In another embodiment, the information to be verified is a fingerprint, and the control unit allows the digital data processor to access to the first logic unit when the fingerprint complies with a preset pattern.

In accordance with a first aspect of the present invention, there is provided a portable digital data storage device for use with a computer system. The portable digital data storage device comprises a non-volatile memory, a verifying unit and a control unit. The non-volatile memory module has a first memory portion accessible through a verifiable information and a second memory portion storing therein an application program that is to be executed to activate a verifying procedure. The verifying unit is used for verifying information entered via a user's operation interface that is created in the verifying procedure. The control unit disallows the first memory portion to be accessed when it is not the verifiable information entered via the user's operation interface.

In an embodiment, the application program is automatically executed when the portable digital data storage device communicates with the computer system via a bus device.

In an embodiment, the bus device includes a universal serial bus (USB), a USB connector arranged on the portable digital data storage device, and a USB socket arranged on the computer system.

In an embodiment, the bus device includes an IEEE 1394 bus, an IEEE 1394 connector arranged on the portable digital data storage device, and an IEEE 1394 bus socket arranged on the computer system.

In an embodiment, the non-volatile memory module is patterned with a first logic unit used as the first memory portion, a second logic unit used as the second memory portion, and a third logic unit open for being arbitrarily accessed by the computer system.

### BRIEF DESCRIPTION OF THE DRAWINGS

The above contents of the present invention will become more readily apparent to those ordinarily skilled in the art after reviewing the following detailed description and accompanying drawings, in which:

FIG. 1 is a circuit block diagram showing the configuration of a conventional computer system;

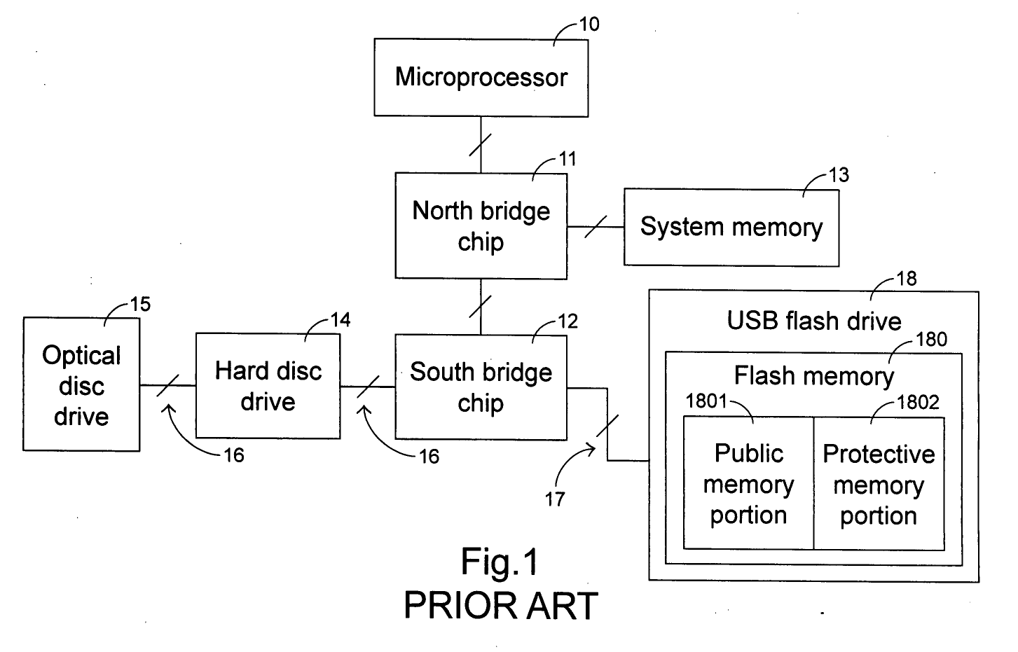

FIG. 2 is a circuit block diagram illustrating a portable digital data storage device according to an embodiment of the present invention and the use thereof with a computer system;

FIG. 3 is a circuit block diagram illustrating the embodiment of the portable digital data storage device of FIG. 2, which uses a password-verifying unit as the verifying unit; and

FIG. 4 is a circuit block diagram illustrating the embodiment of the portable digital data storage device of FIG. 2, which uses a fingerprint-verifying unit as the verifying unit.

### DETAILED DESCRIPTION OF THE PREFERRED EMBODIMENT

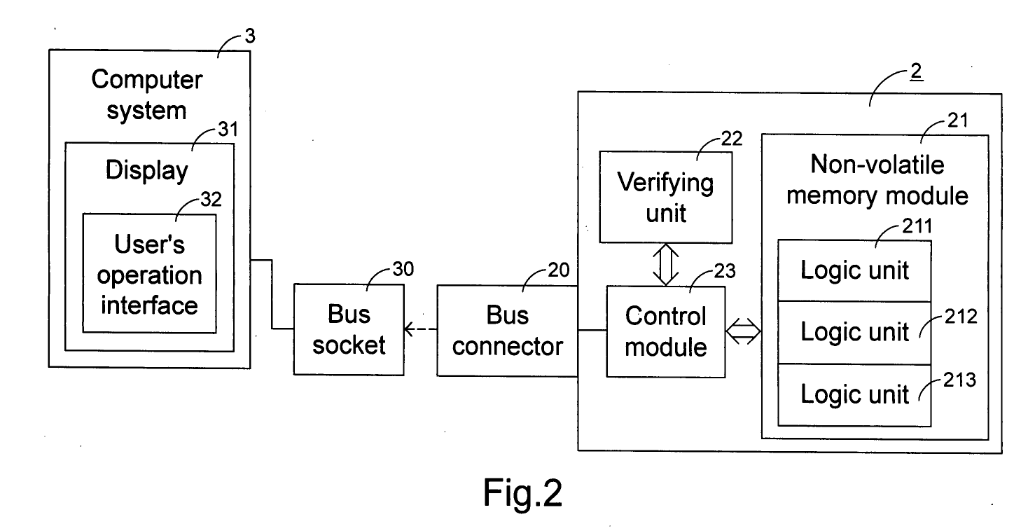

Referring to FIG. 2, a portable digital data storage device 2 according to an embodiment of the present invention is used with a digital data processor such as a computer system 3, and comprises a bus connector 20, a non-volatile memory module 21, a verifying unit 22 and a control module 23.

When the bus connector 20 is plugged into a compatible bus socket 30 of the computer system 3, the portable non-volatile memory device 2 is made in communication with the computer system 3 for data transmission therebetween. The data transmission between the portable digital data storage device 2 and the computer system 3 can be conducted through an associated protocol such as a universal serial bus (USB) or an IEEE 1394 bus. In these examples, the bus connector 20 is a USB connector or an IEEE 1394 bus connector, and the bus socket 30 is a USB socket or an IEEE 1394 bus socket.

The non-volatile memory module 21, e.g. a flash memory or micro drive, comprises three logic units 211˜213 wherein the logic unit 211 stores therein an application program, the logic unit 212 stores therein secured data and the logic unit 213 stores therein public data. The secured data cannot be accessed until a verifying procedure is passed through the verifying unit 22. The application program stored in the logic unit 211 will be automatically executed under the control of the control module 23 once the bus connector 20 is plugged into the bus socket 30 of the computer system 3 to accomplish electric connection between the control module 23 and the computer system 3. The control module 23 is thus exemplified as a USB control module or an IEEE 1394 control module. In response to the execution of the application program, a user's operation interface 32 is shown on a display 31 of the computer system 3. Via the user's operation interface 32, the distribution of the logic units in the non-volatile memory module 21 can be designated, and the verifying information required for passing the verifying procedure in order to access to the logic unit 212 can be set, changed and entered. By entering the correct verifying information, the logic unit 212 of the non-volatile memory 21 becomes accessible by the computer system 3. In contrast, as the public data stored in the logic unit 213 is open for being arbitrarily accessed by the computer system 3, it is not necessary to enter the verifying information to access to the logic unit 213.

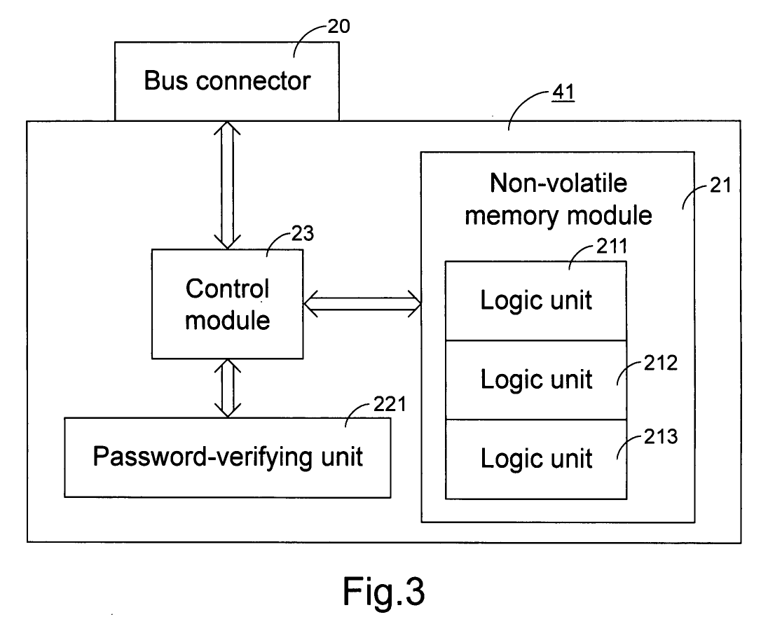

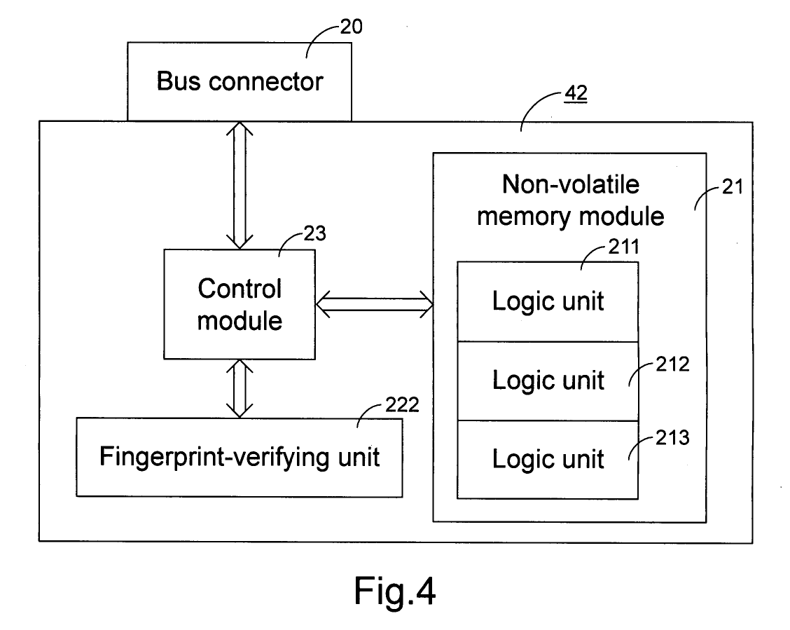

The verifying information required for access to the logic unit 212, for example, can be a password or fingerprint. Correspondingly, the verifying unit 22 is implemented with a password-verifying unit or a fingerprint-verifying unit, as shown in FIG. 3 and FIG. 4, respectively.

Referring to FIG. 3, a password-verifying unit 221 is employed in a portable digital data storage device 41 to verify whether an entered password complies with a preset pattern. In order to successfully access to the logic unit 212 of the non-volatile memory 21, a password should be firstly entered via the user's operation interface 32 illustrated in FIG. 2. The preset pattern of the password has been previously recorded in the non-volatile memory 21. If the password is consistent with the preset pattern, it means the verifying procedure is passed and the computer system 3 is allowed to access to the logic unit 212 of the non-volatile memory 21. On the contrary, the computer system 3 is forbidden to access to the logic unit 212 of the non-volatile memory 21 if the entered password fails to pass the verifying procedure.

Referring to FIG. 4, a fingerprint-verifying unit 222 is employed in a portable digital data storage device 42 to verify whether an entered fingerprint complies with a preset pattern. In order to successfully access to the logic unit 212 of the non-volatile memory 21, the fingerprint of the user should be firstly scanned so as to input fingerprint data via the user's operation interface 32 shown in FIG. 2. Likewise, the preset pattern of the fingerprint graph has been previously recorded in the non-volatile memory 21. If the scanned fingerprint graph is consistent with the preset pattern, it means the verifying procedure is passed and the computer system 3 is allowed to access to the logic unit 212 of the non-volatile memory 21. On the contrary, the computer system 3 is forbidden to access to the logic unit 212 of the non-volatile memory 21 if the fingerprint data fails to pass the verifying procedure.

In a case that the computer system 3 is operated with a Windows® operation system, it is preferred to have the logic units 211 and 213 simulate removable disc drives and have the logic unit 212 simulate an optical disc drive, wherein the application program is stored in a root directory of the virtual optical disc drive. Under this circumstance, the application program will be able to be deemed an autorun program by the computer system 3, and thus can be automatically executed once the electric connection between the portable digital data storage device and the computer system is accomplished.

From the above description, it is understood that the portable digital data storage device of the present invention is capable of implementing data security without installing any application program into the associated computer system in advance or in situ. The data security can be achieved by executing a verifying procedure, for example by a password-verifying device and/or a fingerprint-verifying unit arranged in the portable digital data storage device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A portable digital data storage device comprising:
a connector attachable to a digital data processor to provide electric connection with said digital data processor;
a non-volatile memory module including a first logic unit for storing data and a second logic unit for storing therein an application program, said application program being automatically executed when said connector is electrically connected to said digital data processor to provide a user's operation interface;
a verifying unit for executing a verifying procedure for information entered via said user's operation interface; and
a control unit electrically connected to said connector, said non-volatile memory module and said verifying unit, and disallowing said digital data processor to access to said first logic unit through said connector until the correctness of said information entered via said user's operation interface is verified by said verifying unit.

2. The portable digital data storage device according to claim 1 wherein said digital data processor is a computer system and said connector is a bus connector to be plugged into a bus socket of said digital data processor for transmitting data between said non-volatile memory module and said computer system via a bus.

3. The portable digital data storage device according to claim 2 wherein said bus is a universal serial bus (USB).

4. The portable digital data storage device according to claim 2 wherein said bus is an IEEE 1394 bus.

5. The portable digital data storage device according to claim 1 wherein said non-volatile memory module is a flash memory module.

6. The portable digital data storage device according to claim 1 wherein said non-volatile memory module is a micro drive.

7. The portable digital data storage device according to claim 1 wherein said second logic unit is a virtual optical disc drive, and said application program is stored in a root directory of said virtual optical disc drive.

8. The portable digital data storage device according to claim 1 wherein said non-volatile memory module further includes a third logic unit open for being arbitrarily accessed by said digital data processor.

9. The portable digital data storage device according to claim 8 wherein said first and third logic units are virtual removable disc drives.

10. The portable digital data storage device according to claim 1 wherein said information to be verified is a password, and said control unit allows said digital data processor to access to said first logic unit when said password complies with a preset pattern.

11. The portable digital data storage device according to claim 1 wherein said information to be verified is a fingerprint, and said control unit allows said digital data processor to access to said first logic unit when said fingerprint complies with a preset pattern.

12. A portable digital data storage device for use with a computer system, comprising:
a non-volatile memory module having a first memory portion accessible through a verifiable information and a second memory portion storing therein an application program that is to be executed to activate a verifying procedure;
a verifying unit for verifying information entered via a user's operation interface that is created in said verifying procedure; and
a control unit disallowing said first memory portion to be accessed when it is not said verifiable information entered via said user's operation interface.

13. The portable digital data storage device according to claim 12 wherein said application program is automatically executed when said portable digital data storage device communicates with the computer system via a bus device.

14. The portable digital data storage device according to claim 13 wherein said bus device includes a universal serial bus (USB), a USB connector arranged on said portable digital data storage device, and a USB socket arranged on the computer system.

15. The portable digital data storage device according to claim 13 wherein said bus device includes an IEEE 1394 bus, an IEEE 1394 connector arranged on said portable digital data storage device, and an IEEE 1394 bus socket arranged on the computer system.

16. The portable digital data storage device according to claim 12 wherein said non-volatile memory module is a flash memory module.

17. The portable digital data storage device according to claim 12 wherein said non-volatile memory module is a micro drive.

18. The portable digital data storage device according to claim 12 wherein said application program is stored in a root directory of a virtual optical disc drive of said non-volatile memory module.

19. The portable digital data storage device according to claim 12 wherein said non-volatile memory module is patterned with a first logic unit used as said first memory portion, a second logic unit used as said second memory portion, and a third logic unit open for being arbitrarily accessed by the computer system.
